(19) United States
(12) Patent Application Publication
(10) Pub. No.: US 2021/0244592 A1
(43) Pub. Date: Aug. 12, 2021

(54) TRANSFER MATTRESS CONSTRUCTED AT PARTIALLY OF AN AIR PERMEABLE MATERIAL

(71) Applicant: D.T. DAVID ENTERPRISES, LTD. (d/b/a Hovertech International), Allentown, PA (US)

(72) Inventor: David T. DAVIS, Bethlehem, PA (US)

(73) Assignee: D.T. DAVID ENTERPRISES, LTD. (d/b/a Hovertech International), Allentown, PA (US)

(21) Appl. No.: 17/049,588

(22) PCT Filed: Jun. 20, 2019
(86) PCT No.: PCT/US2019/038161

§ 371 Date: Oct. 22, 2020

Related U.S. Application Data
(60) Provisional application No. 62/687,427, filed on Jun. 20, 2018.

(51) Int. Cl. A61G 7/10

(52) U.S. Cl. CPC A61G 7/1026; A61G 7/1021

(57) ABSTRACT

A transfer mattress includes a top panel and a bottom panel. The bottom panel is engaged with the top panel to form an internal chamber. The bottom panel includes an air permeable portion and an air impermeable portion, wherein the air permeable portion is constructed from an air permeable woven material. The permeable portion and the impermeable portion are configured such that air is able to escape from the internal chamber through the permeable portion and air is not able to escape from the internal chamber through the impermeable portion.

### CROSS-REFERENCE TO RELATED APPLICATIONS

This application claims priority to U.S. Provisional Patent Application No. 62/687,427, filed Jun. 20, 2018, the entirety of which is incorporated herein by reference.

### BACKGROUND

Patient handling mattresses are known in the art which include at least two flexible material sheets, that together define a plenum chamber, with at least one sheet being perforated with small pinholes over at least a central surface area, and which open up directly to the interior of the plenum chamber. Such prior art mattresses are used by arranging the perforated sheet so that it faces an underlying fixed, generally planar support surface, such as a floor or table. When the mattress is charged with pressurized air, the increased volume of air acts initially to jack a load placed upon the mattress above the perforated flexible sheet, and the escape of air under pressure through the pinholes creates an air bearing of relatively small height between the underlying fixed, generally planar support surface and the perforated flexible sheet.

### SUMMARY

In one aspect, a transfer mattress includes a top panel and a bottom panel. The bottom panel is engaged with the top panel to form an internal chamber. The bottom panel includes an air permeable portion and an air impermeable portion, wherein the air permeable portion is constructed from an air permeable woven material. The permeable portion and the impermeable portion are configured such that air is able to escape from the internal chamber through the permeable portion and air is not able to escape from the internal chamber through the impermeable portion.

In another aspect, a method of constructing a transfer mattress includes forming a bottom panel by coupling a permeable layer to an impermeable layer. The method further includes coupling the bottom panel to a top panel to form an internal chamber.

In another aspect, a transfer mattress includes a top panel and a bottom panel. The bottom panel is engaged with the top panel to form an internal chamber. The bottom panel includes an air permeable layer and an air impermeable layer. The permeable layer and the impermeable layer are engaged such that the impermeable layer prevents air from escaping from the internal chamber through a first portion of the bottom panel and allows air to escape from the internal chamber through a second portion of the bottom panel.

### BRIEF DESCRIPTION OF THE DRAWINGS

The features and advantages of the embodiments described herein will be more fully disclosed in, or rendered obvious by the following detailed description of the preferred embodiments, which are to be considered together with the accompanying drawings wherein like numbers refer to like parts and further wherein:

FIG. 1 shows a prior art transfer mattress including perforations in the bottom panel;

FIG. 2 shows a side view of a patient disposed on a transfer mattress according to one embodiment described herein;

FIG. 3 shows a bottom perspective view of a transfer mattress according to one embodiment described herein;

FIG. 4 shows the bottom panel of the transfer mattress of FIG. 2; and

FIG. 5 shows a cross-sectional view of the transfer mattress of FIG. 2.

### DETAILED DESCRIPTION

The description of the preferred embodiments is intended to be read in connection with the accompanying drawings, which are to be considered part of the entire written description. The drawing figures are not necessarily to scale and certain features may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise. The term “operatively coupled” is such an attachment, coupling, or connection that allows the pertinent structures to operate as intended by virtue of that relationship. In the claims, means-plus-function clauses, if used, are intended to cover structures described, suggested, or rendered obvious by the written description or drawings for performing the recited function, including not only structure equivalents but also equivalent structures.

When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive; as another example, the phrase “about 8%” preferably (but not always) refers to a value of 7.2% to 8.8%, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.”

The present disclosure describes various embodiments of an inflatable mattress including a top panel and a bottom panel coupled together at the edges, either directly or via a perimeter band. The top panel and the bottom panel define a mattress perimeter having a proximal (or head) end and a distal (or foot) end. The bottom panel is composed, at least partially, of an air permeable material that allows air to escape from the interior of the mattress, through the bottom panel, to form a layer of air between the mattress and the supporting surface. This allows a patient disposed on the mattress to be easily moved and positioned. The use of the permeable material can reduce or eliminate the need to mechanically perforate the panel, thereby reducing production cost and increasing throughput.

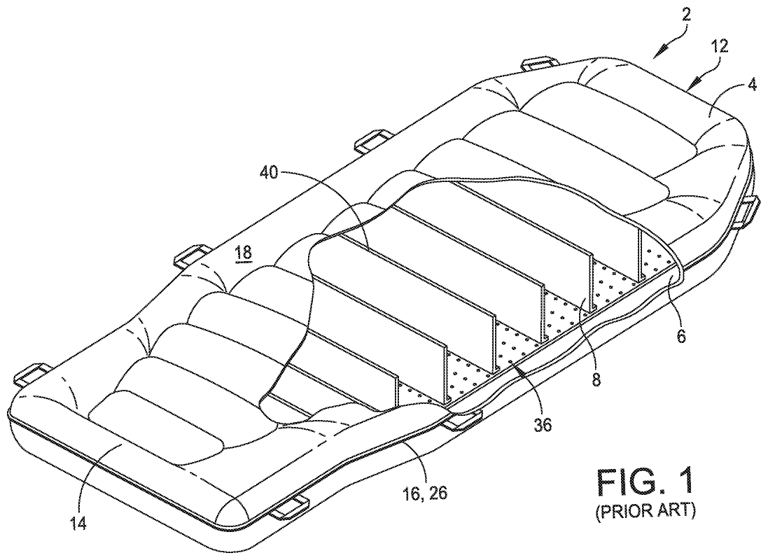

FIG. 1 shows a partial cut-away view of a prior art inflatable transfer mattress 2. The transfer mattress 2 includes a top panel 4, a bottom panel 6 and a plurality of stringers 8 extending between the top panel 4 and the bottom panel 6. A top edge 40 of the stringers 8, which is coupled to the top panel 4, is shown. The top panel 4 includes a head portion 12, a foot portion 14, and a peripheral edge 16. An outer surface 18 of the top panel 4 may be coated with a water proof coating.

As shown in FIG. 1, the bottom panel 6 includes a plurality of tiny holes 36 that are defined through its thickness to allow air, that is supplied by a low-pressure air supply to transfer mattress 2, via an air supply hose (not shown), to escape in a controlled manner. The air supplied to the transfer mattress 2 escapes through the plurality of holes 36, providing a weight-bearing cushion of air that facilitates the sliding of transfer mattress 2 along a surface, as well as, from one surface to another.

As will be described in detail below, in the transfer mattresses described herein, the bottom panel is constructed, at least partially, from a permeable material that allows air to escape through the bottom panel. This avoids the need to perforate the bottom panel during manufacturing. In some embodiments, it also creates a more uniform air bearing beneath the mattress, thereby improving the ability of a caregiver to easily transport a patient disposed on the transport mattress.

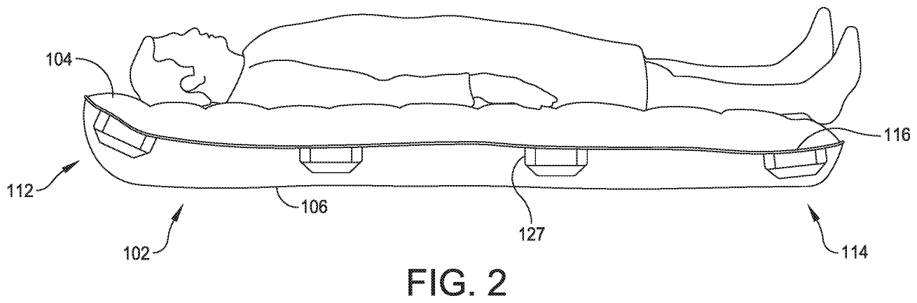

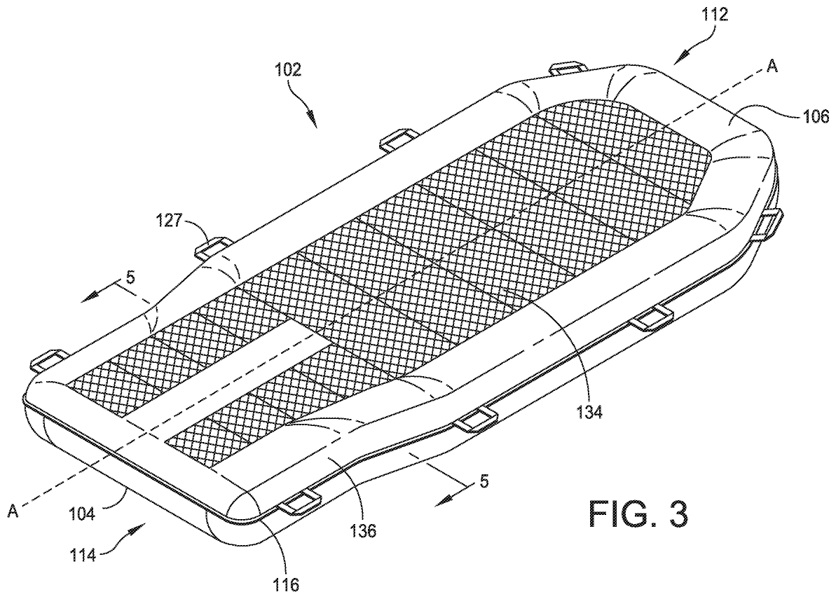

Referring to FIGS. 2 and 3, a transfer mattress 102 formed in accordance with the present embodiments comprises a top panel 104 and a bottom panel 106 joined to form an internal chamber of the transfer mattress 102. The inflatable mattress includes a proximal end 112, a distal end 114, and a perimeter 116. An inlet opening (not shown) can be formed in a portion of the transfer mattress 102, and may be a closable opening that sealingly accepts an air supply hose. The inlet opening can be sized and shaped so that the air supply hose may be inserted, with the inlet being thereafter snapped shut or otherwise closed to hold the air supply hose in place while the transfer mattress 102 is being inflated. The inlet opening may also include a valve (not shown) that is biased to be normally closed to prevent air from exiting through the inlet, and opened when an air supply hose is inserted into the inlet opening. Other arrangements may be used to inflate the transfer mattress 102. The transfer mattress 102 can also include a plurality of handles 127 to allow for easy handling and movement of the inflatable mattress.

The top panel 104 and the bottom panel 106 are engaged along their peripheral edges to form the perimeter 116 of the transfer mattress 102. Although the illustrated embodiment includes a top panel 104 and a bottom panel 106 defining identical perimeters, it will be appreciated that the top panel 104 and/or the bottom panel 106 can define different perimeters. The top panel 104 and bottom panel 106 can be directly engaged, for example by radiofrequency welding, adhesives, weldable hook fasteners, sewing, heat sealing, ultrasonic welding, or the like. Alternatively, in some embodiments, a perimeter band (not shown) is coupled between the top panel 104 and the bottom panel 106.

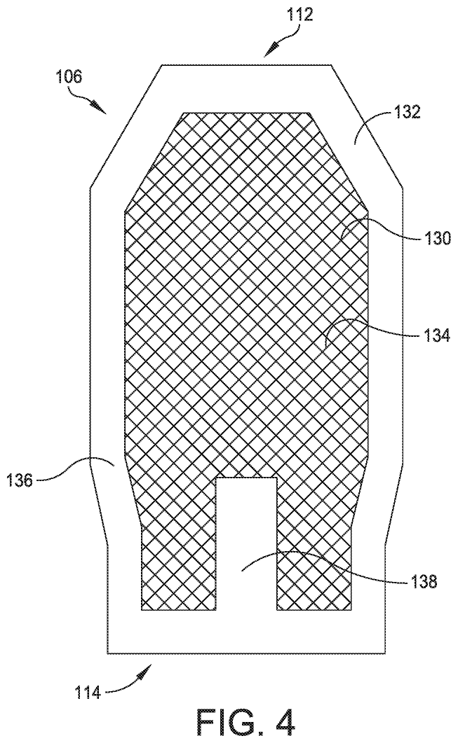

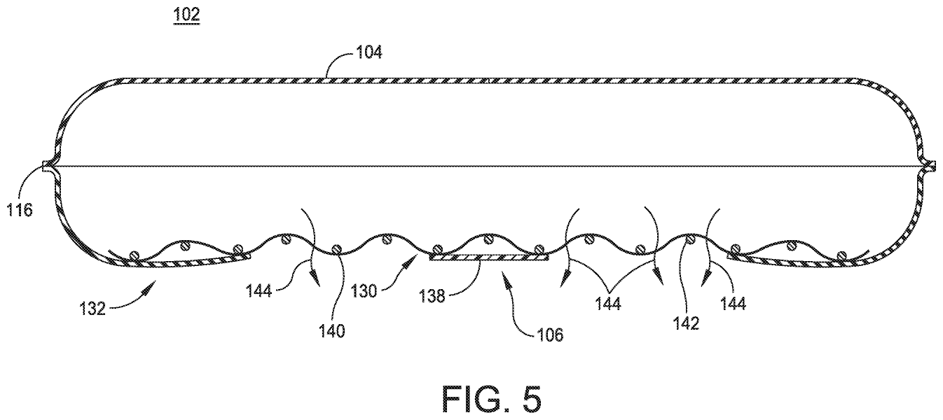

As shown in FIGS. 3-5, the bottom panel 106 includes an air permeable layer 130 (shown in FIGS. 4 and 5) that allows air (supplied by an air supply to transfer mattress 102) to escape in a controlled manner. In addition, in some embodiments, the bottom panel 106 also includes a relatively air impermeable layer 132 (shown in FIGS. 4 and 5) that prevents air from flowing through portions of the bottom panel 106. This arrangement provides a first portion 134 of the bottom panel 106 through which air is able to escape and a second portion 136 through which air is unable to escape. The air supplied to transfer mattress 102 escapes through the first portion 134, providing a weight-bearing cushion of air that facilitates the sliding of transfer mattress 102 along a surface, as well as from one surface to another. The configuration of the first portion 134 and the second portion 136 controls the flow of air through the bottom panel 106 and directs the air to the regions of the transfer mattress 102 that provide support for the patient.

FIG. 4 shows a bottom panel 106 according to one embodiment. The bottom panel 106 includes a permeable layer 130 and an impermeable layer 132. In one embodiment, the air permeable layer 130 extends across the entire bottom panel 106 and is joined at its edges to top panel 104 or to a perimeter band (not shown). In other embodiments, the permeable layer 130 spans only a portion of the bottom panel 106. In such embodiments, the impermeable layer 132 is joined to the top panel 104 or the perimeter band (as shown in FIG. 5). The air impermeable layer 132 partially covers the permeable layer 130 to restrict airflow therethrough. The impermeable layer 132 can be disposed either on top of or beneath the permeable layer 130. In other words, the impermeable layer 132 can be within the interior chamber of the mattress 102 or, alternatively, on the exterior of the mattress 102 (as shown in FIG. 5).

The permeable layer 130 and the impermeable layer 132 can be arranged in any configuration to direct airflow to the desired locations beneath the transfer mattress 102. For example, in one embodiment shown in FIG. 4, the impermeable layer 132 covers the perimeter of the bottom panel 106 to prevent air from flowing through the bottom panel 106 at the perimeter. This directs the airflow to the area beneath the patient to provide support for the patient. In addition, the impermeable layer 132 can include a central extension 138 positioned along the longitudinal axis “A” (shown in FIG. 3) of the transfer mattress 102 near its distal end 114. The central extension 138 is configured to be positioned approximately between a patient's legs. Thus, the extension 138 further directs air to beneath the portions of the transfer mattress 102 that support the patient.

The impermeable layer 132 can be configured to cover any portion of the bottom panel 106. In one embodiment, the impermeable layer 132 covers about 50% of the surface area of the bottom panel 106. In another embodiment, the impermeable layer 132 covers between about 25% and about 75% of the surface area of the bottom panel.

In embodiments in which the impermeable layer 132 covers the perimeter of the bottom panel 106, the impermeable layer 132 can extend any distance from the edge of the bottom panel 106. In one embodiment, the impermeable layer 132 is wider at the proximal end 112 and the distal end 114 than at the lateral sides of the inflatable mattress. In another embodiment, the impermeable layer 132 is thinner at the proximal end 112 and the distal end 114 than at the lateral sides of the inflatable mattress.

The permeable layer 130 can comprise any appropriate air permeable material. In one embodiment, the permeable layer comprises a woven material, such as a woven fabric. For example, the permeable layer can comprise a nylon scrim material.

In embodiments in which the permeable layer 130 is a woven material, the geometry of the weave can be configured to provide the desired permeability of the material and, thereby, the desired airflow through the bottom panel 106.

The impermeable layer 132 can comprise any appropriate air impermeable material. For example, in one embodiment, the impermeable layer is constructed of polyester.

In some embodiments, the impermeable layer 132 is contiguous (i.e., all portions of the impermeable layer 132 are connected). In other embodiments, the impermeable layer 132 includes more than one disconnected portions.

The permeable layer 130 and the impermeable layer 132 can be joined in any appropriate manner. For example, the impermeable layer 132 can be joined to the permeable layer 130 by bonding, RF welding, stitching, heat sealing, ultrasonic welding or any appropriate method.

FIG. 5 shows a cross-sectional view of the transfer mattress 102 showing the arrangement of the air permeable layer 130 and the air impermeable layer 132, wherein the air permeable layer 130 is constructed from a woven material. The weave and fibers of the air permeable layer 130 are shown embellished for illustration purposes. As shown, the air permeable layer 130 may include weft fibers 140 and warp fibers 142. The interstitial spaces between the fibers 140, 142 allow air to flow out of the interior chamber of the transfer mattress, as illustrated by arrows 144. The arrows 144 show that the air is directed to the areas between air impermeable layer 132. Because the weave can be configured with varying densities (i.e., varying distribution of interstitial spaces), the use of an air permeable woven material in lieu of manufactured holes in the bottom panel may lead to a more homogenous air bearing beneath the transfer mattress 102. This may allow for easier movement of the mattress and the patient.

While the embodiments described above include permeable and impermeable layers to form the air permeable first portion 134 and air impermeable second portion 136, it should be understood that in other embodiments, the bottom panel 106 is constructed of a single layer of material that is configured with air permeable and air impermeable portions. For example, in one embodiment, the bottom panel 106 is constructed of a woven material in which a portion of the woven material has a tight weave that prevents the passage of air therethrough and another portion of the woven material has a relatively looser weave that allows the passage of air therethrough. In still other embodiments, an air impermeable material is stitched or welded to an air permeable material along respective edges to form the bottom panel 106, with the permeable and impermeable materials sized and configured to provide the desired air permeable and air impermeable portions of the bottom panel 106.

It should be understood that some or all of the top panel 104 and the perimeter band (not shown), and any stringers within the transfer mattress 102 can be formed from a sheet of fabric, e.g., nylon scrim or the like, and may be coated on at least the outer surface with an air impermeable coating. One or more surfaces of the transfer mattress 102 can also be coated with a water proof coating. The water proof coating may be any of the well-known polymeric or elastomeric compounds that are known to be impervious to semi-solids and liquids, such as, blood, urine, feces, hospital strength disinfecting compounds, alcohol, or the like. For example, a nylon twill fabric that is coated on one side with a heat sealable, polyurethane coating (e.g., an inner side) and the outer side coated with a Durable Water Repellant (Patient side). A practical benefit associated with the use of the foregoing preferred materials is that the transfer mattress 102 retains a better appearance for longer periods of time during use. A double coated transfer mattress 102 can be easily wiped down, and can be put back into use more quickly.

Alternatively, in those instances where a single use, single patient mattress is provided, i.e., where patient use lasting less than twenty four hours is desired, some or all of the top panel 104, the bottom panel 106, and the perimeter band (not shown) may be formed from fibers for forming fabrics suitable for single use. For example, top panel 104 may be made of materials, such as, acetate, acrylic, anidex, aramid, azlon, cotton, elastoester, fluorocarbon, fur, glass, lyocell, melamine, metallic, modacrylic, modal, mosacrylic, novoloid, nylon, nytril, olefin, PAN, PBI, PEEK, Pelco, PEN, PLA, PTT, polyester, polyester-polyarylate, rayon, saran, spandex, sulfar, triacetate, vinal, vinyon, and wool. A common characteristic of the foregoing and like materials is their propensity to stain or discolor as a result of contact with blood, urine, feces, hospital strength disinfecting compounds, alcohol, or the like. Additionally, a variety of films may be used to form a single patient, single use transfer mattress 102, for example, copolyester, copolyether, ethylene vinyl acetate, fluorocarbon, polyamide, olefins, polybutylene, polycarbonate, polyester, polystyrene, polyurethane, polyvinyl, alcohol, polyvinyl chloride, polyvinyl fluoride, and polyvinylidene chloride. A practical benefit associated with the use of the foregoing preferred materials is that such a transfer mattress 102 retains a stained and discolored appearance for longer periods of time after use thereby alerting hospital staff or other care givers that a particular transfer mattress 102 has completed its useful life, and must be discarded.

In one embodiment, some or all of the top panel 104, the bottom panel 106, and the perimeter band (not shown) may comprise a cold water soluble partially hydrolyzed polyvinyl alcohol, cold water insoluble hot water disintegrable aliphatic polyester, and minor proportions of processing and performance aids. The aliphatic polyester has a melt temperature above the normal body temperature of a human (approximately 37° C. or 98.6° F.) and is present in the resin blend at a concentration sufficient to constitute the continuous phase of the blend, with the polyvinyl alcohol constituting a discontinuous phase of the blend. The aliphatic polyester renders the resin blend, and the partially hydrolyzed polyvinyl alcohol in the blend, cold water insoluble and determines the temperature at which articles formed from the blend will be subject to dissolution in an aqueous bath and subsequent disposal. A practical benefit associated with the use of the foregoing material is that such a transfer mattress 102 not only retains a stained and discolored appearance for longer periods of time after use, thereby alerting hospital staff or other care givers that a particular transfer mattress 102 has completed its useful life, and must be discarded, but also if an attempt is made to launder the mattress after a single use it disintegrates during the washing process.

While the foregoing description and drawings represent preferred or exemplary embodiments of the present invention, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention. All patents and published patent applications identified herein are incorporated herein by reference in their entireties.

What is claimed is:

1. A transfer mattress, comprising:
a top panel; and
a bottom panel engaged with the top panel to form an internal chamber, the bottom panel including an air permeable portion and an air impermeable portion, wherein the air permeable portion is constructed from an air permeable woven material;
wherein the permeable portion and the impermeable portion are configured such that air is able to escape from the internal chamber through the permeable portion and air is not able to escape from the internal chamber through the impermeable portion.

2. The transfer mattress of claim 1, wherein the bottom panel comprises an air permeable layer coupled to an air impermeable layer to form the permeable portion and the impermeable portion.

3. The transfer mattress of claim 2, wherein the permeable layer spans the entire bottom panel and is joined to the top panel and wherein the impermeable layer is within the internal chamber of the transfer mattress and covers a portion of the permeable layer.

4. The transfer mattress of claim 2, wherein the permeable layer is constructed from nylon scrim.

5. The transfer mattress of claim 2, wherein the impermeable layer is constructed from a polyester material.

6. The transfer mattress of claim 1, wherein the impermeable portion includes a perimeter of the bottom panel to prevent air from escaping from the internal chamber through the perimeter of the bottom panel.

7. The transfer mattress of claim 6, wherein the impermeable portion includes a central extension extending along a longitudinal axis of the transfer mattress at a distal end of the transfer mattress.

8. The transfer mattress of claim 1, wherein the impermeable portion covers between about 25% and about 75% of the surface area of the bottom panel.

9. The transfer mattress of claim 1, wherein the impermeable portion covers about 50% of the surface area of the bottom panel.

10. A method of constructing a transfer mattress, comprising:
forming a bottom panel by coupling a permeable layer to an impermeable layer; and
coupling the bottom panel to a top panel to form an internal chamber.

11. The method of claim 10, wherein the permeable layer spans the entire bottom panel, and wherein coupling the bottom panel to the top panel comprises joining the permeable layer and the top panel.

12. The method of claim 10, wherein the permeable layer comprises a woven material.

13. The method of claim 12, wherein the permeable layer is constructed from nylon scrim.

14. The method of claim 10, wherein the permeable layer is constructed from a polyester material.

15. The method of claim 10, wherein the permeable layer and the impermeable layer are configured such that the impermeable layer covers a perimeter of the bottom panel.

16. The method of claim 10, wherein the impermeable layer covers between about 25% and about 75% of the surface area of the bottom panel.

17. A transfer mattress, comprising:
a top panel; and
a bottom panel engaged with the top panel to form an internal chamber of the transfer mattress, the bottom panel including an air permeable layer and an air impermeable layer;
wherein the permeable layer and the impermeable layer are engaged such that the impermeable layer prevents air from escaping from the internal chamber through a first portion of the bottom panel and allows air to escape from the internal chamber through a second portion of the bottom panel.

18. The transfer mattress of claim 17, wherein the permeable layer spans the entire bottom panel and is joined to the top panel and wherein the impermeable layer is within the internal chamber of the transfer mattress and covers a portion of the permeable layer.

19. The transfer mattress of claim 17, wherein the impermeable layer covers a perimeter of the bottom panel to prevent air from escaping from the internal chamber through the perimeter of the bottom panel.

20. The transfer mattress of claim 19, wherein the impermeable layer includes a central extension extending along a longitudinal axis of the transfer mattress at a distal end of the transfer mattress.
